(19) United States
(12) Patent Application Publication
(10) Pub. No.: US 2007/0150410 A1
(43) Pub. Date: Jun. 28, 2007

(54) Loan marketing method and apparatus

(75) Inventor: Al Salahi, La Canada, CA (US)

Correspondence Address: WILLIAM W. HAEFLIGER, 201 S. LAKE AVE, SUITE 512, PASADENA, CA, 91101, US

(73) Assignee: NameYourLoan

(21) Appl. No.: 11/318,943

(22) Filed: Dec. 27, 2005

(51) Int. Cl. G06Q 40/00

(52) U.S. Cl. 705/38; 705/37

(57) ABSTRACT

The method of determining the best commercial loan interest rate, which includes scanning the loan market for the lowest interest rate available among reputable banks or mortgage lenders; setting that rate as a benchmark rate; selecting a group of bid participating banks, and mortgage lenders willing to participate in a generally simultaneous or by a deadline bid competition causing the group to submit generally simultaneous or by a deadline available loan rate bids to compete with the benchmark rate, and selecting one of the submitted bids as a winning low rate loan bid.

### BACKGROUND OF THE INVENTION

This invention relates generally to establishing favorable loan rates of interest, and more particularly to a method of determining the most favorable, or best, loan rate as a result of bidding procedures.

There is need for efficiently and effectively establishing most favorable loan rates from a selected group of loan source institutions such as banks, mortgage lenders, and the like. In particular, there is need for enhancing competition in competitive loan rate bidding procedures.

### SUMMARY OF THE INVENTION

It is a major object of the invention to provide an improved and highly efficient procedure to establish a most favorable loan rate, when a number of bidders are involved. Basically, the method of the invention comprises:

a) scanning the loan market for the lowest interest rate available among reputable banks or mortgage lenders,

b) setting that rate as a benchmark rate.

c) selecting a group of bid participating banks, and mortgage lenders willing to participate in a generally simultaneous or by a deadline bid competition,

d) causing said group to submit generally simultaneous available loan rate bids to compete with said benchmark rate,

e) selecting one of said submitted bids as a winning low rate loan bid.

If customer has already shopped around and obtained a quote, one could use that quote as the benchmark to get participating banks and lenders to bid lower on that benchmark.

The bidding process could be performed by phone, fax, e-mail, mail, in person, electronically or computerized.

As will be seen, the benchmark rate may be established as an APR rate, and the bidding institutions are advised of the benchmark rate to enable them to efficiently bid at levels in relation to that benchmark rate, thereby eliminating non-competitive bids above benchmark level.

Another object includes advising the competitive bidders to all submit their bids at particular times, so that such bids can be quickly processed without need or opportunity to revise their bids. They could also submit their bids by a deadline, and lowest bidder wins. This process could be repeated more than once but each time the new lowest rate would be the benchmark. As the bids come in, the lowest bid at any time become the new benchmark. Banks and lenders will be informed by phone, fax, in person, electronically or via computer display.

Another object includes advising the competitive bidders to submit bids in the form of APR bids, that is bids that combine pure rates with points, in accordance with established mathematical formulae.

Yet another object is to provide for the benchmark rate level which takes into account current loan rates quoted by a number of selected loaning institutions.

These and other objects and advantages of the invention, as well as the details of an illustrative embodiment, will be more fully understood from the following specification and drawings, in which:

### DRAWING DESCRIPTION

FIG. 1 is a block or flow diagram showing a procedure to establish a benchmark rate level; and

FIG. 2 is a block or flow diagram showing a procedure to utilize the benchmark rate in a competitive bidding procedure involving selected bidding institutions.

### DETAILED DESCRIPTION

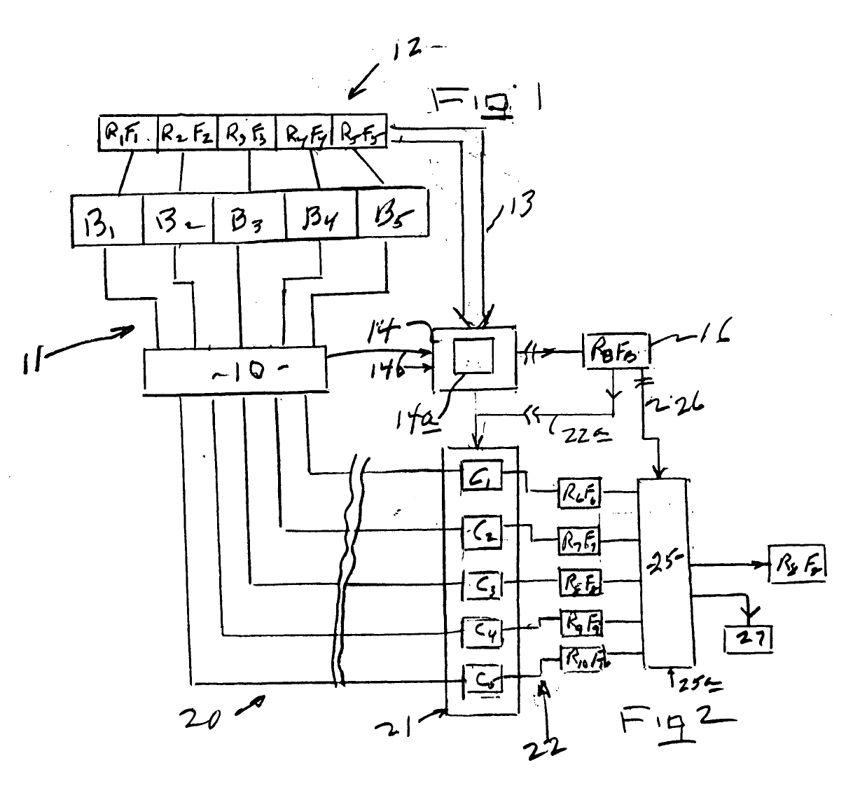

Referring first to FIG. 1, it diagrammatically shows method and means for effecting the first two steps of the method of the invention, which are as follows:

a) scanning the loan market for the lowest interest rate available among reputable banks or mortgage lenders,

b) setting that rate as a benchmark rate,

Thus, a loan originator 10, who may for example be a mortgage broker, scans, at 11, the market represented by reputable banks or loaning institutions, B₁ - - - B₅ - - - Bₙ for the lowest interest rate and fees that is available. Such scanning may be by telephone, fax, e-mail, done electronically or computerized, or other means. The available rates and fees quoted by B₁ - - - B₅ - - - Bₙ are indicated at R₁F₁ - - - R₅F₅, for example, and as a group at 12.

That quoted information is then used to establish a benchmark rate R_{B}F_{B} indicated at 16. Processing to derive the benchmark rate as shown at 13, 14, and 15, i.e. with inputs from 10 and 12. Processor 14 may include a comparator 14a to compare R₁F₁ - - - R₅F₅ - - - RₙFₙ, according to a predetermined program 14a set by 10. In general, R_{B}F_{B}, is an average value compiled from R₁F₁ - - - RₙFₙ.

If desired, R_{B} and F_{B} can be combined to establish an APR benchmark.

Referring now to FIG. 2, it diagrammatically shows method and means for effecting the three steps c), d), and e), of the method of the invention, which are as follows:

c) selecting a group of bid participating banks, and mortgage lenders willing to participate in a generally simultaneous bid competition,

d) causing said group to submit generally simultaneously available loan rate bids to compete with said determined benchmark rate,

e) selecting one of said submitted bids as a winning low rate loan bid.

As shown, the loan originator 10, or someone with whom it is associated, selects (as indicated at 20) a group 21 of bid participating reputable banks, or other lenders, indicated at C₆ - - - - C₁O - - - - Cₙ, who may or may not be inclusive of one or more of B₁ - - - B₅ - - - Bₙ. The selection is made to ensure that C₆ - - - C₁₀ - - - Cₙ are willing to participate in a simultaneous, or generally simultaneous, bid submission competition, to commit to bid loan rates and fees indicated at R₆F₆ - - - R₁₀F₁₀ after C₆ - - - C₁₀ - - -Cₙ are informed of the benchmark rate R_{B}F_{B}, or the APR benchmark, as referred to. The step d) of causing the group 21 of banks or institutions to submit the indicated bid rate R₆F₆ - - - R₁₀F₁₀ is indicated at 22, and may include advising at 22a the group 21 that their bids should be less than R_{B}F_{B}, in order to achieve orderly control of bidding by many selected banks or lenders, at desirably low levels, enhancing competition among selected banks or lenders, considering that one or more of C₆ - - - C₁₀ - - - Cₙ may drop out of the bidding process, either prior to bidding, or during the bidding process, which is desirably simultaneous or generally simultaneous to promote bidding by as many of the selected banks or lenders, as possible.

A selection is then made of one of the selected bids, as a winning low rate loan bid, for example R₈F₈, and the bank or lender C₃ submitting that bid is informed. The selection may include comparison at 25 with the benchmark rate inputted at 26, so that if, for example, only two or three submitted bid rates are sufficiently below the benchmark rate, a second and similar bidding process can be effected, as indicated at 27, whereby the banks or lenders who submitted those low rates can re-submit bids, knowing that their original bids were below the benchmark.

Accordingly, a very efficient, practical and competitive process and means is provided to derive a winning a low loan rate bid, from reputable banks or lenders.

Mathematical criterion for the comparison operator at 14, and the comparison operation at 25, are inputted at 14b and 25a.

The system contemplated by the invention includes:

a) first means for scanning the loan market for the lowest interest rate available among reputable banks or mortgage lenders,

b) second means for setting that rate as a benchmark rate,

c) third means for selecting a group of bid participating banks, and mortgage lenders willing to participate in a generally simultaneous bid competition,

d) fourth means for causing said group to submit generally simultaneous available loan rate bids to compete with said benchmark rate,

e) fifth means for selecting one of said submitted bids as a winning low rate loan bid.

Elements of the system correspond to the steps a) - - - e) of the method described, and the corresponding identifying numerals for said steps. The system may also be embodied in a computer or operated over the Internet.

The invention further contemplates operation as by the following options:

1. Participating Banks and Mortgage lenders may be charged for a periodic membership fee to participate in the biddings, and/or

2. Participating Banks and Mortgage lenders could be charged a fee every time they want to participate and bid on a given client, and/or

3. Participating Banks and Mortgage lenders could be charged multiple fees for a given client. In other words, if multiple bidding occurs for one client, every time the lenders bid, they are charged a fee. The fee would be smaller than a one time fee such as No. 2 above; and/or

4. A fee may be charged only to the winning bidder, and/or

5. One could charge no fees to the lenders, and rather charge the borrower for getting them the lowest offer; and/or

6. One could charge no fees to the lenders and rather profit by having originator 10 close the loan, or through an affiliate or subsidiary of 10, earning a commission and/or earning a premium yield spread and/or earn money by selling the loan on the secondary market for a premium.

I claim:

1. The method of determining the best commercial loan interest rate, that includes:
a) scanning the loan market for the lowest interest rate available among reputable banks or mortgage lenders,
b) setting that rate as a benchmark rate,
c) selecting a group of bid participating banks, and mortgage lenders willing to participate in a generally simultaneous or by a deadline bid competition,
d) causing said group to submit generally simultaneous or by a deadline available loan rate bids to compete with said benchmark rate,
e) selecting one of said submitted bids as a winning low rate loan bid.

2. The method of claim 1 wherein said benchmark rate is an APR rate.

3. The method of claim 1 wherein said group of bid participating banks and mortgage lenders are advised of said benchmark rate prior to step d).

4. The method of claim 1 wherein said step d) includes advising said group to submit their bids at a selected time.

5. The method of claim 1 wherein said step d), includes advising said group to submit their bids as APR bids.

6. The method of claim 1 wherein said step a) includes a comparison step to compare a series R₁F₁ - - - R₅F₅ - - - RₙFₙ loan rates provided by a series of selected banks and/or loan institutions B₁ - - - B₅ - - - Bₙ.

7. The method of claim 1 wherein said step e) includes a comparison step to compare a series of below benchmark rate bids provided by a series of banks and/or load institutions C₆ - - - C₁₀ - - - Cₙ.

8. The method of claim 1 including providing a re-bidding process whereby certain banks and/or institutions submitting bids below the benchmark rate can re-bid at lower levels in order to establish a winning bid.

9. The method of claim 1 wherein said steps a) and e) include providing and operating comparators.

10. A system for determining the best commercial loan interest rate, comprising:
a) first means for scanning the loan market for the lowest interest rate available among reputable banks or mortgage lenders,
b) second means for setting that rate as a benchmark rate,
c) third means for selecting a group of bid participating banks, and mortgage lenders willing to participate in a generally simultaneous bid competition,
d) fourth means for causing said group to submit generally simultaneous available loan rate bids to compete with said benchmark rate,
e) fifth means for selecting one of said submitted bids as a winning low rate loan bid.

11. The method of claim 18 wherein said first means and said fifth means include comparators.
